(19) United States
(12) Patent Application Publication
(10) Pub. No.: US 2013/0055109 A1
(43) Pub. Date: Feb. 28, 2013

(54) DISPLAY DATA GENERATION APPARATUS, DISPLAY CONTROL SYSTEM AND DISPLAY CONTROL PROGRAM

(71) Applicants: Shunsuke TAKAMURA, Kokubunji-shi (JP); Moeko HAGIWARA, Ichikawa-shi (JP); Toshihiro MOTOI, Toshima-ku (JP); Yoichi KAWABUCHI, Itami-shi (JP); Yasuhiko YAMAGUCHI, Hino-shi (JP); Kenta HOSAKA, Sagamihara-shi (JP)

(72) Inventors: Shunsuke TAKAMURA, Kokubunji-shi (JP); Moeko HAGIWARA, Ichikawa-shi (JP); Toshihiro MOTOI, Toshima-ku (JP); Yoichi KAWABUCHI, Itami-shi (JP); Yasuhiko YAMAGUCHI, Hino-shi (JP); Kenta HOSAKA, Sagamihara-shi (JP)

(73) Assignee: Konica Minolta Business Technologies, Inc., Chiyoda-ku (JP)

(21) Appl. No.: 13/586,072

(22) Filed: Aug. 15, 2012

(30) Foreign Application Priority Data
Aug. 23, 2011 (JP) 2011-181343

(51) Int. Cl. G06F 3/048

(52) U.S. Cl. 715/753

(57) ABSTRACT

A display data generation device which generates display data to display a plurality of objects on a shared image screen utilized by a plurality of users, includes: a processing and judgment section which identifies a user who has conducted an operation to any one of the objects when the operation is detected, and judges whether or not a display form of the object should be changed according to a change of the user who operated the object; and an image processing section to generate display data in which the display form of the object has been changed, in accordance with a judgment result of the processing and judgment section.

This application is based on Japanese Patent Application No. 2011-181343 filed on Aug. 23, 2011, which is incorporated hereinto by reference.

### BACKGROUND OF THE INVENTION

The present invention relates to a display data generation apparatus, a display control system, and a display control program, and, in particular, to a display data generation apparatus which generates display data that are displayed on a shared screen by a plurality of users, a display control system including the display data generation apparatus, and a display control program operating on the display data generation apparatus.

At a meeting and the like, discussion is carried out by using a shared screen, which can be used by a plurality of users, and by writing, on the shared screen, a display element such as a character, a figure, and an image (hereinafter, it is referred to an object). In such the shared screen, in the case of where the whole discussion carried out so far is observed by decreasing the display in size, if the display size is reduced in a constant reduction ratio, the object may become indecipherable. Because of these backgrounds, a method is used in which, for an important object, the object is highlighted by, for example, increasing its size so that the flow and constitution of the whole discussion can be easily understood.

With regard to a technology to highlight a specific object, in, for example, Japanese Patent Application Publication No. 2009-009519, there is disclosed an information display apparatus which is provided with a display section, a page obtaining unit, which obtains a web page, a page display control unit, which displays the web page obtained by the page obtaining unit on the above display section, a user operation performing unit, which performs an operation desired by a user to the web page displayed on the above display section by the page display control unit, an operation history storing unit, which stores the history of user operation to the above web page, which was performed by the user operation performing unit, and a highlighting control unit, which highlights a high frequency part of the user operation on the aforesaid web page, at a time when the above web page is displayed on the above display section by the above page display control unit, based on the history of user operation to the aforesaid web page which was stored by the above operation history memorizing unit.

Further, in Japanese Patent Application Publication No. H05-165570, there is disclosed a touch screen input apparatus, which has a learning function, in which a high input frequency item can be replaced to the top position, and a highlighting function, in which a high input frequency item can be enlarged or color-coded, using a touch screen apparatus, in which an input format can be freely selected, in an automatic apparatus such as a ticketing terminal, and further has a output watching function which retains the selected item until an output processing is finished.

In the case where a plurality of objects are arranged and displayed, it is possible to easily determine which object is important by highlighting a specific object. However, it is troublesome for the user to set which object should be highlighted.

In the case where operations are carried out by one person, as it is described in Japanese Patent Application Publication Nos. 2009-009519 and H05-165570, it is also possible to highlight an object according to operation frequency of the object. However, since this method highlights an object which is operated many times by one operator, there is a problem that an object which is important for the whole group cannot be properly recognized, when a screen, on which objects are displayed, is used by a plurality of users.

### SUMMARY OF THE INVENTION

The present invention was performed in consideration of the above problems, and the main purpose of the invention is to provide a display data generation apparatus, a display control system, and a display control program, which can highlight an appropriate object, at a time when a plurality objects are displayed on a screen, which is shared by a plurality of people.

In order to achieve the above purpose, the present invention is a display data generation apparatus which generates display data, in which apparatus a plurality objects are displayed on a shared screen used by a plurality users, and the apparatus is provided with at least a processing and judging section, which, when an operation to any one of objects is detected, recognizes a user who carried out the above operation, and, according to a change of the user who operates the above object, judges if a display form of the above object should be changed, and an image processing section, which generates display data in which the display form of the above object is changed according to the judging result of the above processing and judging section.

Further, the present invention is a display control program operating on an apparatus, which generates display data, in which a plurality objects are displayed on a shared screen used by a plurality of users, and the above apparatus is made to function as a processing and judging section, which, when an operation to any one of objects is detected, recognizes a user who carried out the above operation, and, according to a change of the user who operates the above object, judges if a display form of the above object should be changed, and an image processing section, which generates display data in which the display form of the above object is changed according to the judging result of the above processing and judging section.

### BRIEF DESCRIPTION OF THE DRAWINGS

FIG. 1 is a schematic illustration showing a structure of the display control system relating to an example of the present invention.

FIG. 2 is a block diagram showing a structure of the display control system of FIG. 1.

FIG. 3 is a schematic illustration showing another structure of the display control system relating to an example of the present invention.

FIG. 4 is a block diagram showing a structure of the display control system of FIG. 3.

FIG. 5 is a flow chart showing operations of the display control system relating to an example of the present invention.

FIG. 6 is a figure showing an example of a modification method of the display form relating to an example of the present invention.

FIG. 7 is a figure showing another example of a modification method of the display form relating to an example of the present invention.

FIG. 8 is a figure showing another example of a modification method of the display form relating to an example of the present invention.

FIG. 9 is a figure showing an example of operation history information relating to an example of the present invention.

FIG. 10 is a figure showing another example of operation history information relating to an example of the present invention.

FIG. 11 is a figure showing another example of a modification method of the display form relating to an example of the present invention.

FIGS. 12A to 12C are figures showing a transition example of the shared screen relating to an example of the present invention.

### DETAILED DESCRIPTION OF THE PREFERRED EMBODIMENT

As described in the section of BACKGROUND OF THE INVENTION, at a meeting or the like, a shared screen used by a plurality of users is frequently used, and, when a plurality objects are displayed on a screen, if they are evenly displayed, it is hard to understand which object is important. In particular, in the case where the whole discussion is observed by decreasing the shared display in size, each object is displayed small, making the object become indecipherable, therefore it becomes difficult to understand the flow and structure of the whole discussion.

As a method for highlighting a specific object, there may be one, in which a user sets an object to be highlighted, but, this method is troublesome for the user since the user is required to select the object in each case. As disclosed in Japanese Patent Application Publication Nos. 2009-009519 and H05-165570, in the case where operations are carried out by one person, there may be a method, in which an object is highlighted according to an operation frequency of the object However, this method highlights an object which is operated many times by one person, and therefore there is a problem that an important object cannot be properly recognized when the screen is shared by a plurality of users.

Therefore, in one embodiment of the present invention, it is designed so that, at a time when a plurality of objects (such as a character and a figure) are arranged and displayed, a display form of an object is changed (object is highlighted) according to a change of the operator who operated the object. In addition, it is designed so that, in the case where a person who operates the object for the first time operated it, the display form of the object is changed.

Specifically, when an operation (such as transfer or decoration of an object, creation of a related object, and pronunciation of wording related to an object) was carried out to an object which was displayed on a shared screen used by a plurality of users, the operator who carried out the operation is recognized, and then, according to a change of the operator (that is, when a different operator operated the object), a display form (a size, density, a color or the like) of the object is changed to highlight the object. Further, with reference to preliminarily stored operation history information, it is judged if the recognized operator is the one who carried out the operation to the object for the first time, and if the operator is the one who carried out the operation for the first time, the display form of the object is changed, or the amount of the change of the display form of the object is controlled according to the number of the operators who carried out the operation for the first time.

In this way, by highlighting an object according to a change of an operator, the display becomes more visible, and the whole constitution can be understood more easily. Further, by highlighting an object according to the number of operators, it becomes possible to reflect more correctly the degree of attention from the whole participants. In addition, since an important object is displayed larger than other ones when the whole contents written in the shared screen are displayed to observe them, no important object is missed.

### Example

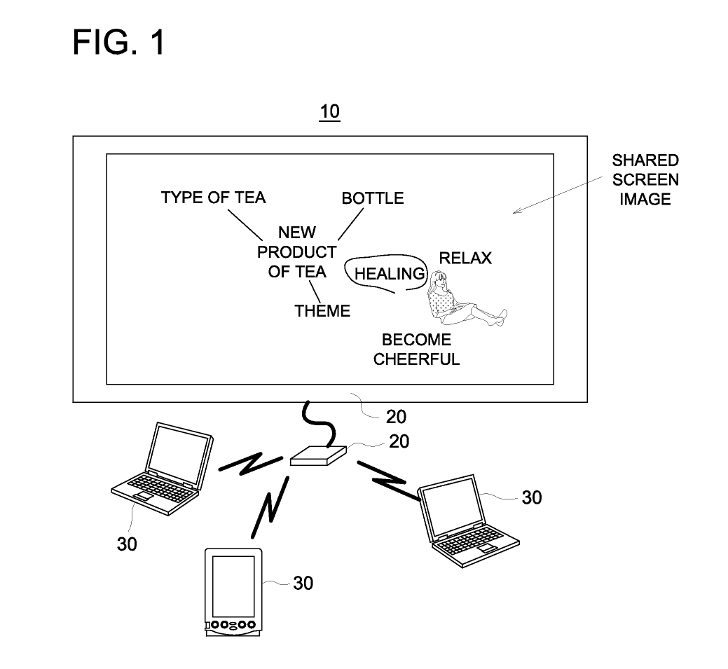

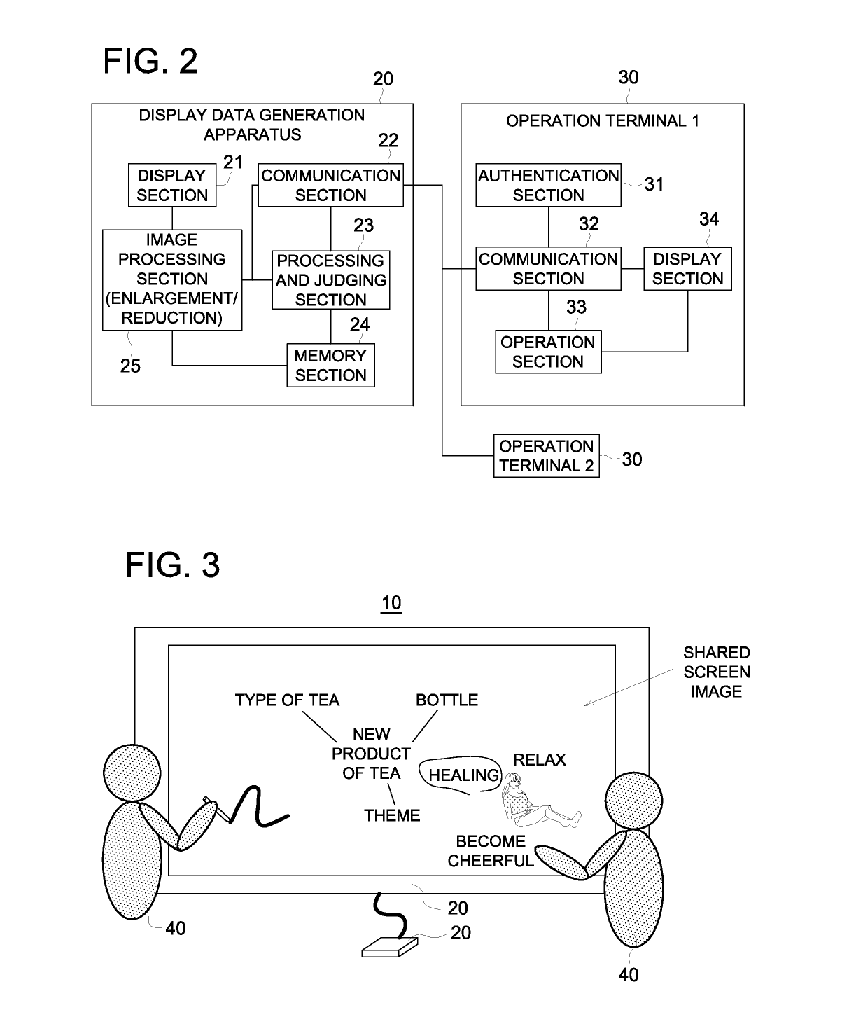

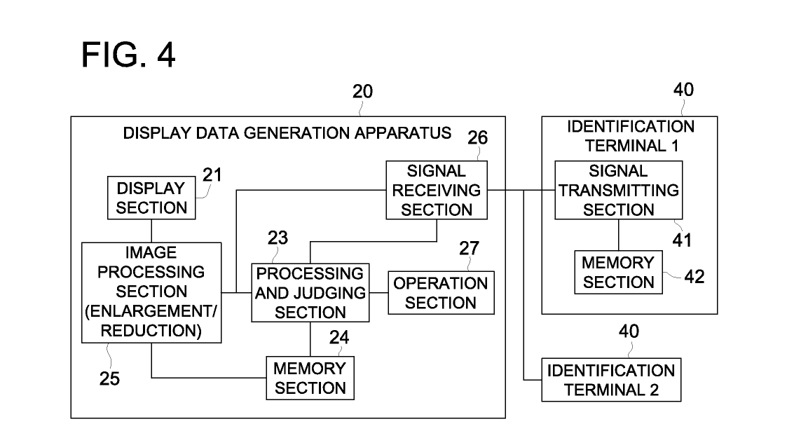

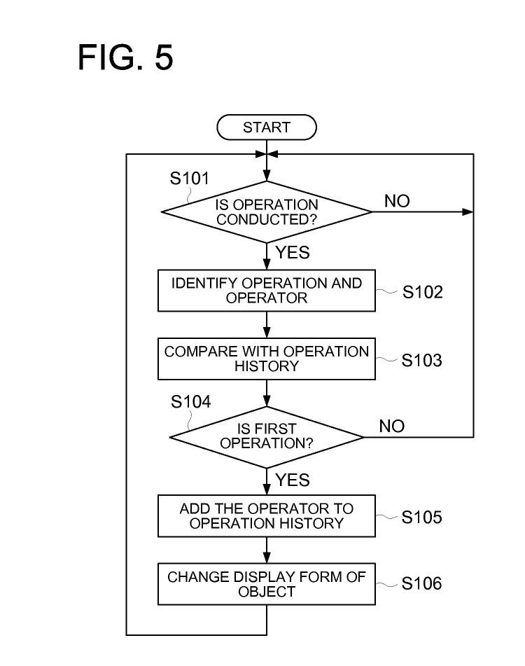

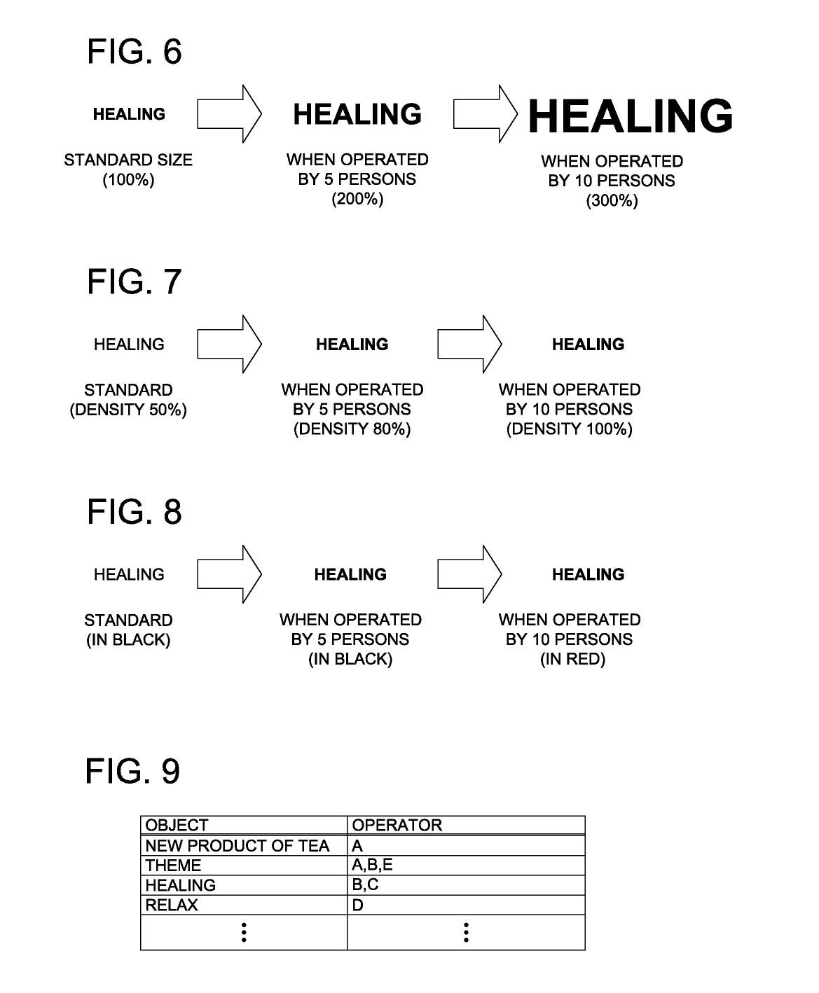

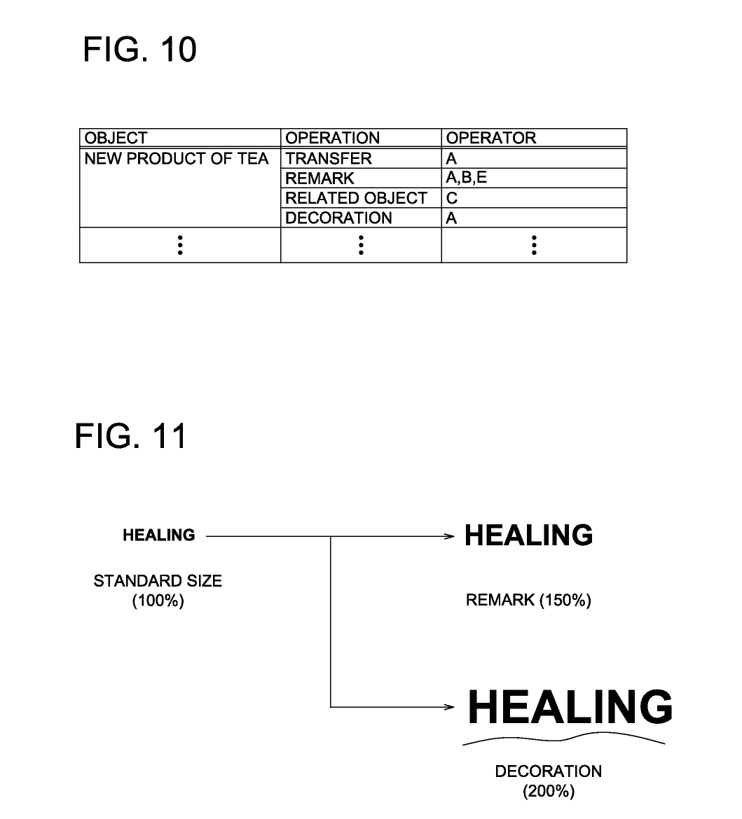

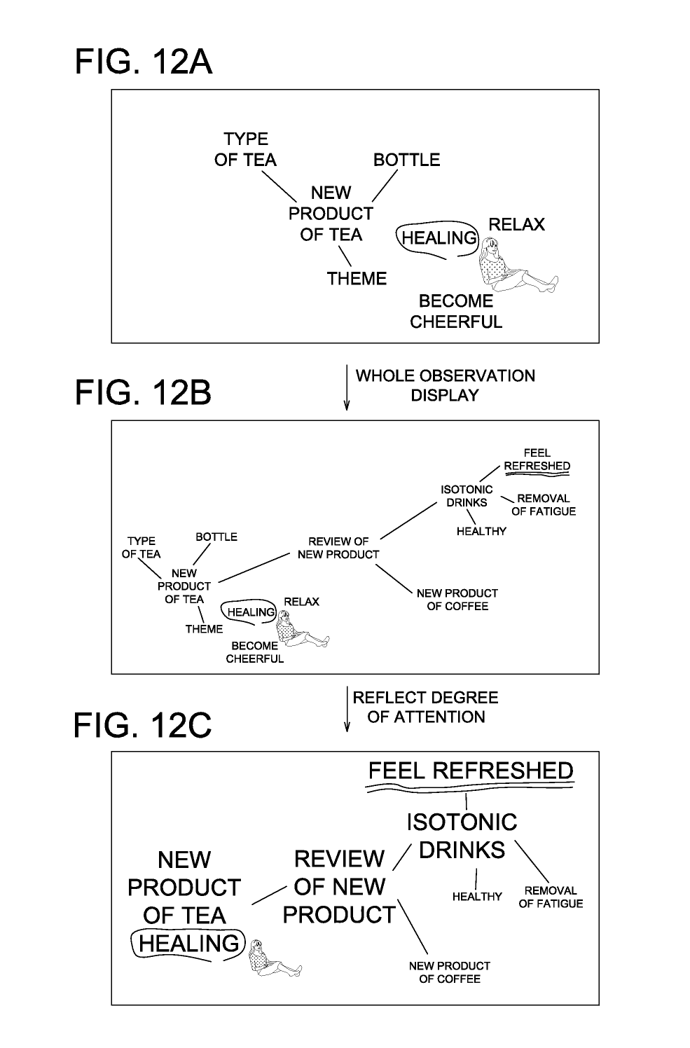

In order to further detail the above embodiment of the present invention, there will be described a display data generation apparatus, a display control system, and a display control program relating to one example of the present invention, with reference to FIGS. 1 to 12C. FIGS. 1 and 3 are schematic illustrations showing a structure of the display control system of the present example, and FIGS. 2 and 4 are block diagrams showing a structure of the display control system. FIG. 5 is a flow chart showing operations of the display control system of the present example, and FIGS. 6-8 and 11 are figures showing an example of a modification method of the display form of the present example. Further, FIGS. 9 and 10 are figures showing an example of operation history information, and FIGS. 12A to 12C are figures showing a transition example of the shared screen of the present example.

The display control system of the present example is provided with a display data generation apparatus which generates data (hereinafter referred to as display data) to display a plurality objects on a shared screen used by a plurality users, and a display apparatus to display a plurality objects based on the display data. The display data generation apparatus and the display apparatus may be different, or may be an integrated one.

This display control system has a different structure between a case where a user operates an object using an operation terminal and a case where a user directly operates an object on a display apparatus. Hereinafter, the structures of each of the above cases are described with reference to figures.

FIG. 1 is a schematic illustration showing a first structure of display control system 10 of the present example, and display control system 10 is constituted of display data generation apparatus 20 which generates display data including a plurality of objects and displays them on a shared screen, operation terminal 30 in which each operator operates to an object displayed on the shared screen, and the like. Hereinafter, each apparatus will be detailed with reference to FIG. 2.

### [Display Data Generation Apparatus]

Display data generation apparatus 20 includes display section 21, communication section 22, processing and judging section 23, memory section 24, image processing section 25, and the like.

Display section 21 is composed of a liquid crystal display (LCD), an organic EL (electro luminescence) display apparatus, or the like, and provides a shared screen used by a plurality of users. On the shared screen, plural objects are displayed, and it is designed so that each of the objects can be selected individually.

Communication section 22 is constituted of an NIC (network interface card), a modem, and the like, and communicates with operation terminal 30, which is connected with a network through wire communication or wireless communication, to receive operation information or identification information of the operator from operation terminal 30.

Processing and judging section 23, when obtains operation information, identification information of the operator, or the like from operation terminal 30 through communication section 22, and detects an operation to an object, compares operation history information stored in memory section 24 with the obtained identification information of the operator, and then, judges whether the operator is the one who carried out the operation to the object for the first time. In the case where the operator is the one who carried out the operation to the object for the first time, processing and judging section 23 instructs image processing section 25 to change the display form of the object.

Memory section 24 is constituted of memories such as a ROM (read only memory) and a RAM (random access memory), a HDD (hard disk drive), or the like, and stores data of the object and operation history information (information showing who operated which object in the past) to each object.

Image processing section 25 generates display data, which are composed of object data stored in memory section 24 and are displayed on a shared screen, and sends them to display section 21, as well as transmits them to operation terminal 30 through communication section 22. Further, image processing section 25, when image processing section 25 received an instruction from processing and judging section 23, follows the instruction, and, according to a change of an operator (for example, according to the number of operators who carried out the operation for the first time), changes the display form of an object, and then generates display data to display the object in the changed display form.

### [Operation Terminal]

Operation terminal 30 includes authentication section 31, communication section 32, operation section 33, display section 34, and the like.

Authentication section 31 compares user information such as a user ID and a password which were inputted by operation section 33 with user information which was previously stored to authenticate an operator. The authentication method is not limited to the ID or the password, but biological information such as fingerprint patterns and vein patterns may be used.

Communication section 32 includes an NIC, a modem or the like, and communicates with display data generation apparatus 20, which is connected with a network through wire communication or wireless communication, to receive display data of a display which is displayed on a shared screen from display data generation apparatus 20, or to transmit operation information or identification information of an operator to display data generation apparatus 20.

Operation section 33 is constituted of a mouse, a keyboard, and the like, and receives an input of user information or an operation (operation such as transfer or decoration of an object, and creation of a related object) to an object displayed on display section 34.

Display section 34 is composed of a liquid crystal display, an organic EL display apparatus, or the like, and, based on display data obtained from display data generation apparatus 20, displays the same screen as a shared screen.

The outline of action of above display control system 10 will be described. A user performs a personal authentication at authentication section 31 of operation terminal 30. With this action, operation terminal 30 obtains identification information of the operator. Next, operation terminal 30, through communication section 32, receives display data, which are displayed on a shared screen, from display data generation apparatus 20, to display them on display section 34.

When the user, while looking at a screen displayed on display section 34, operates operation section 33, to instruct an operation of an object, communication section 32 sends the operation information and the identification information of the operator to display data generation apparatus 20.

When display data generation apparatus 20, through communication section 22, receives the operation information and the identification information of the operator from operation terminal 30, processing and judging section 23 compares operation history information stored in memory section 24 with the above obtained information, to identify the operator of the object, and then, according to the change of the operator (for example, according to if the operator operated the object for the first time), judges whether or not the display form of the object should be changed. Then, in the case where the display form of the object should be changed, an instruction of the change of the display form to image processing section 25 is carried out.

Image processing section 25, based on the instruction received from processing and judging section 23, changes the display form of the object (enlargement and reduction of each object), according to the change of the operator (for example, according to the number of operators who carried out the operation for the first time). Then, these objects are composed to generate display data, which are then sent to display section 21. Display section 21 displays the object, in which the display form was changed based on the display data, on a shared screen.

FIG. 3 is a schematic illustration showing a second structure of display control system 10 of the present example, and display control system 10 is constituted of display data generation apparatus 20 which generates display data including a plurality of objects and displays them on a shared screen, identification terminal 40 to identify each user, and the like. Hereinafter, each apparatus will be detailed with reference to FIG. 4.

### [Display Data Generation Apparatus]

Display data generation apparatus 20 includes display section 21, processing and judging section 23, memory section 24, image processing section 25, signal receiving section 26, operation section 27, and the like. Since the constitution of display section 21, processing and judging section 23, memory section 24, image processing section 25 are the same as those described above, descriptions thereof are omitted.

Signal receiving section 26 is a signal receiver to communicate with identification terminal 40 by a communication method utilizing a human body (dielectric substance) as a communication medium, and is set up on or near display section 21. Signal receiving section 26 receives identification information from identification terminal 40 by coming close to an operator of identification terminal 40.

Operation section 27 is a pressure sensitivity type or a capacitance type touch screen or the like, in which transparent electrodes are arranged in a lattice pattern on the front or back surface of display section 21, and receives an operation to an object (an operation such as transfer or decoration of an object, and creation of a related object) displayed on the shared screen.

### [Identification Terminal]

Identification terminal 40 is constituted of signal transmitting section 41, memory section 42, and the like.

Signal transmitting section 41 is signal transmitter to communicate with display data generation apparatus 20 by a communication method utilizing a human body (dielectric substance) as a communication medium, and sends a signal of identification information or the like of the operator to display data generation apparatus 20, by passing an electric current through the body of the operator in an electric current method, or by providing a signal to an electrostatic layer of the body surface of the operator in an electric field method.

Memory section 42 has a ROM, a RAM, or the like, and stores identification information or the like of the operator.

The outline of action of above display control system 10 will be described. When a user performs an operation to an object which is displayed on display section 21 of display data generation apparatus 20, signal transmitting section 41 of identification terminal 40 sends identification information of the operator to display data generation apparatus 20 through the body of the user (human body communication). Signal receiving section 26 of data generation apparatus 20 receives identification information of the operator from identification terminal 40.

Processing and judging section 23, once obtains operation information from operation section 27 (a touch screen), and then obtains identification information of an operator from signal receiving section 26, refers the identification information to the operation history information stored in memory section 24 to identify the operator of the object, and, according to the change of the operator (for example, according to whether or not the operator operated the object for the first time), judges whether or not to change the display form of the object. In the case to change a display form of an object, an instruction of changing the display form is made to image processing section 25.

Image processing section 25, based on the instruction received from processing and judging section 23, and according to the change of the operator (for example, according to the number of operators who operated the above object for the first time), changes the display form of the object (enlargement and reduction of each object). Then, these objects are combined to generate a display data, which are then sent to display section 21. Display section 21 displays the objects, in which the display form was changed based on the above display data, on the shared screen.

In this example, the constitution was made in such a way that operation terminal 30 or identification terminal 40 sends identification information to display data generation apparatus 20, but, for example, it is also possible that a camera, which takes an image of the whole meeting room, is arranged to recognize an operator from a camera image. In this case, it may be constituted so that image recognition is carried out by the camera to identify the operator, and then the identification information of the operator is send to display data generation apparatus 20, or it may be constituted so that image recognition is carried out by display data generation apparatus 20, which received the camera image from the camera, to identify the operator.

Further, it may also be constituted in such a way that each of participants has an RFID (radio frequency identification) tag, and the RFID tag is detected by an RFID reader which is arranged at display section 21 of display data generation apparatus 20 to locate its position, and, from its position information and position or time in which the operation was carried out (was written), the operation information is made responsive to the identification information of the operator. In addition, it may also be constituted in such a way that a position is located by communication between display data generation apparatus 20 and identification terminal 40 by using near field communication represented by Bluetooth (a trademark) or infrared communication, and, from its position information and position or time in which the operation was carried out, the operation information is made responsive to the identification information of the operator.

Though, in FIGS. 1 to 4, the constitution is made so that display data generation apparatus 20 is provided with display section 21, it may also be constituted so that display section 21 (in the cases of FIGS. 3 and 4, display section 21, signal receiving section 26, and operation section 27) is used as an independent display apparatus, and display data generation apparatus 20 controls a display of the display apparatus.

Processing and judging section 23 and image processing section 25 of display data generation apparatus 20 may be constituted as a hardware, or it may also be constituted in such a way that display data generation apparatus 20 is structured as a display control program which is functioned as processing and judging section 23 and image processing section 25, and the aforesaid display control program is operated on display data generation apparatus 20.

Hereinafter, operations of display control system 10 (display control system 10 having structures shown in FIGS. 3 and 4) of the present example will be described with reference to the flowchart of FIG. 5.

First, display data generation apparatus 20 judges whether an operation to an object was carried out by control section 27 (in the case of display control system 10 having structures shown FIGS. 1 and 2, whether operation information was received from operation terminal 30) (S 101). When an operation was carried out to an object, operation section 27 informs of the operation information to processing and judging section 23, and communication section 22 informs of identification information of the operator obtained from identification terminal 40 to processing and judging section 23. Then, processing and judging section 23 identifies which object was operated at operation section 27 based on the operation information, as well as identifies the operator based on the operation information of the operator (S102).

Next, processing and judging section 23 takes out the operation history information of the operated object from memory section 24 to make comparison, and confirms if once the operator had operated the object (S103). In the case where once the operator had operated the object (in case of NO in step S104), the step goes back to step S101 without doing anything. On the other hand, in the case of the operation being performed for the first time (in case of YES in step S104), the identification information of the operator is added to the operation history information of the object (S105).

And then, processing and judging section 23 sends an instruction to image processing section 25 to change the display form of the object, and image processing section 25 changes the display form of the object (S106) according to the instruction of processing and judging section 23. Then, image processing section 25 generates display data, which display the object with a new display form (the display form of the non-operated object is not changed), to send them to display section 21, and display section 21, based on the display data, displays the object with the new display form on a shared screen. After that, the step goes back to step S101 to keep watch on an operation of the object.

Hereinafter, the changing method of the display form of an object will be described with reference to figures.

FIG. 6 is an example of a case to change the display size of an object, and the display size of an object is changed according to the number of operators (the number of operators who operated the object for the first time) with a standard display size being as a base. For example, in the case where the display magnification increases by 20% per one operator increase, if the number of the operators becomes five, the display magnification increases by 100% (5×20%=100%) to become 200%, and if the number of the operators becomes ten, the display magnification increases by 200% (10×20%=200%) to becomes 300%. It may be designed so that every time an operation is carried out, an object size is increased at a constant rate (for example, at 120%) from the current display size. Further, not a constant rate, but the changing rate may be gradually increased or decreased according to the number of the operators, or, with setting a threshold in the number of operators, the display size may be changed if the number of operators exceeds the threshold, or the display size may be changed until the number of operators exceeds the threshold.

FIG. 7 is an example of a case to change the density of an object, and the density of an object is gradually changed according to the number of operators. For example, with the standard density being 50% in black, the density is changed in such a way that the density is set to be 80% if the number of operators becomes five or more, and to be 100% if the number of operators becomes ten or more.

FIG. 8 is an example of a case to change the display color of an object, and the display color is changed if the number of operators, who operate the display color of an object, exceeds a constant number. For example, with the standard display color being black, if the number of operators becomes 10 or more, the display color is changed to a striking color (for example, red). In this case, the display form can also be gradually set, by using a plurality of colors and preparing for a plurality of levels to be changed.

The numerical values indicated in FIGS. 6 to 8 are exemplifications and can be suitably changed. The changing method of the display form is not limited to the structures of FIGS. 6 to 8, but the display form may be changed to one which can be highlighted according to the number of operators. For example, in the case where the object is a character, the thickness of the line may be changed according to the number of operators (the more the number, the thicker the line). Further, in the case where an operation is possible in which the whole image displayed on a shared screen is enlarged or reduced, an object, for example, whose display size became smaller than a constant value due to reduction, may not be displayed. It may also be designed so that the minimum size according to the number of operators is set, and, even if the whole display size is reduced, the display size may not become smaller than the minimum size. By carrying out such control, even in the case where the whole display is reduced to observe the whole objects, it becomes possible to decipher an important object having been operated by many operators, and therefore it becomes easy to understand the whole structure.

Next, the control method of an operation history will be described. As it is shown in FIG. 9, to each object being present on a shared screen, a list is made, in which operators who had operated the object are recorded, and the list is kept in memory section 24. Then, when an operation was carried out to an object, the operator thereof is compared with operators corresponding to the aforesaid object in the list, and then, if the above operator is not recorded in the list, the above operator is added to the list, and then the display form is changed.

On this list, operation items may further be added, and operators may be recorded by type of operations of each object. FIG. 10 is an example of a list in which operators are recorded by type of operations of an object, and when an operation is carried out to an object, there is made comparison of the operator corresponding to the operation of the object in the list. With this action, in the case where a different operation is carried out to one object, the display form can be changed as an object attracting a great deal of attention.

Further, a weighting factor is set for each type of operations (a weighting factor is low for a remark, high for a decoration, and the like), and the amount of changes of display form may be changed according to the weighting factor, and, by carrying out such control, each object may be displayed with a degree of attention corresponding to each operation. FIG. 11 shows an example of changes of a display form of a case where weighting was carried out corresponding to a type of operation. In the case where a keyword corresponding to an object was remarked, the display magnification is changed to 150%, and in the case where a decoration was made to an object (such as in the case where an object is underlined, or an object was enclosed by a line), the display magnification is changed to 200% to highlight the object compared to the case of the remark.

In the ease where a “remark” is recognized as an operation of an object, in display control systems 10 of structures shown in FIGS. 3 and 4, signal receiving section 26 is made to have a function to receive voice data of a microphone, as well as processing and judging section 23 is made to have a voice recognition function. Further, each operator is equipped with a microphone, and information which matches the operator with the microphone is stored in memory section 24.

In addition, when creating an object, a keyword indicating the object is given to the created object, which keyword is then stored in memory section 24. For example, in the case where an object is a character or a document, the wording itself is registered as a keyword of the object. In the case of a picture or a graphic, a keyword is designated by a user to be registered.

In such structure, when one of operators makes a remark, signal receiving section 26 receives voice data from a microphone to give notice to processing and judging section 23, which then analyses the content of the remark using a voice recognition function, to extract a keyword. Then, processing and judging section 23 compares each of analyzed keywords with a keyword given to each of objects, and, if they agreed with each other, judges that an operation of a remark to the object was carried out.

In the above, there was described a case where display data generation apparatus 20 receives voice data from a microphone, but in the case of display control systems 10 of structures shown in FIGS. 1 and 2, operation terminal 30 may receive the voice data from the microphone, and may send them to display data generation apparatus 20. Further, in the above description, an operator (a person who made a remark) is recognized based on the microphone, but a microphone may be placed in the room to collect voices of all operators, and the operator (the person who made a remark) may be recognized by analyzing the voice prints.

In the above, there was described a case where a display form of each object is changed, but hereinafter a display example when the whole display is observed on a screen (reduced) will be described with reference to FIGS. 12A to 12C.

When a working screen such as shown in FIG. 12A is displayed, in the case where operation section 27 of display data generation apparatus 20 or operation section 33 of operation terminal 30 was operated to instruct the “whole observation display” (or to instruct a reduction of the display), all objects written so far are displayed with the objects being equally reduced as shown in FIG. 12B.

In this case, image processing section 25 changes a display form according to the number of operators of each object, and displays a screen for observing the whole display such as shown in FIG. 12C. In this example, since related objects are created on objects such as a “new product of tea”, “review of new product”, and “isotonic drinks”, the display forms are changed (in this example, sizes are enlarged). In addition, since objects such as “healing” and “feel refreshed” are decorated with a circle or an underline, the display forms of these objects are changed (in this example, sizes are enlarged). With these changes, each operator becomes easily able to recognize important objects. Further, when displaying a screen for observing the whole display, it is also possible to delete a display of an object which size became small so that it was hard to make out, and, with this action, it becomes possible to display an important object with being more emphasized.

As it was described above, when displaying a plurality of objects being arranged in a shared screen, it is possible to highlight an attracted object by keeping history information of an operator stored to each object, and by changing a display form of the object according to a change of the operator of the object, by changing a display form of the object in the case where a person who operates for the first time operated, or by adjusting the amount of changes of a display form of an object according to the number of operators who operate for the first time.

The present invention is not limited to the description of the above example, and the structure or the control thereof can be appropriately changed, as long as the changes do not depart from the scope of the present invention.

For example, in FIGS. 1 and 3, as display data generation apparatus 20, a structure was shown in which a box type control section is added to display section 21 which becomes a shared screen, but display data generation apparatus 20 is not limited to the description in the figure, and an optional apparatus, which is for example provided with a display section such as a computer, may be made.

Further, in the above example, it is made so that a display form is changed (an object is highlighted) in the case where an operator operates the object for the first time, which is because a display form is not changed in the case where an identical operator repeated many times an operation to the object. However, in the case where an operator operated the object, after which another operator operated the object, even if the aforesaid another operator is not an operator who operates the object for the first time, the object is thought to be highly important. Therefore, in the case where the operator of the object is replaced by another operator, even if the operator is not one who operates the object for the first time, a display form of the object may be changed. When doing so, in the case where the amount of changes of a display form is controlled according to the number of operators, if a case where an identical operator operated the object many times and a case where different operators operated the object are equally treated, the degree of importance of the object may not be adequately reflected. Therefore, in the case where an identical operator operated an object, it is also possible to control the change so as to change the display form with the smaller amount of changes.

The present embodiment is usable for an apparatus generating display data which are displayed on a shared screen used by a plurality of users, a system being provided with the aforesaid apparatus, and a program operating on the aforesaid apparatus.

According to the display data generation apparatus, the display control system, and the display control program of the present embodiment, when a plurality of objects are displayed on a screen shared by a plurality of users, an adequate object is displayed with being highlighted.

The reason for that is that, when an operation (such as transfer or decoration of an object, creation of a related object, and pronunciation of wording related to an object) was carried out to an object which was displayed on a shared screen used by a plurality of users, the display data generation apparatus (the display control program) recognizes the operator who carried out the operation, and then, according to a change of the operator, carries out a control which changes the display form (size, density, color or the like) of the object to highlight it.

The further reason for that is that, with reference to preliminarily stored operation history information, the display data generation apparatus (the display control program) judges if the recognized operator is the one who carried out the operation to the object for the first time, and, if the operator is the one who carried out the operation for the first time, carries out a control to change the display form of the object, or to regulate the amount of the changes of the display form according to the total number of the above operators.

What is claimed is:

1. A display data generation device which generates display data to display a plurality of objects on a shared image screen utilized by a plurality of users, comprising:
a processing and judgment section which identifies a user who has conducted an operation to any one of the objects when the operation is detected, and judges whether or not a display form of the object should be changed according to a change of the user who operated the object; and
an image processing section to generate display data in which the display form of the object has been changed, in accordance with a judgment result of the processing and judgment section.

2. The display data generation device of claim 1, further comprising a memory section which stores information of an operation history of a user for each object, wherein the processing and judgment section judges whether or not the user who has conducted the operation is a user who has conducted the operation for the first time by referring the information of the operation history, and judges the display form of the object should be changed when the user is judged as a user which conducted for the first time.

3. The display data generation device of claim 2, wherein the processing and judgment section adjusts an amount of change in the display form of the object according to the number of users who have conducted the operation of the object.

4. The display data generation device of claim 3, wherein a weighting factor by each type of operations is set to the operation of the object, and the processing and judgment section adjusts the amount of change in the display form of the object in accordance with the weighting factor according to each type of operations.

5. The display data generation device of claim 1, wherein the display form includes any one of a size of the object, a display density of the object, and a color of display of the object.

6. The display data generation device of claim 1, wherein the operation to the object includes a transfer of the object, decoration of the object, a creation of an object related to the object, and a remark of words related to the object.

7. A display control system comprising:
the display data generation device of claim 1;
a display device which displays the plurality of objects on the shared image screen based on the display data; and
an operation terminal which conducts an operation of the objects,
wherein the display data generation device identifies the operation to the object and the user who has conducted the operation based on the information of the operation to the object which has been obtained from the operation terminal and information of the user.

8. A display control system comprising:
the display data generation device of claim 1;
a display device which displays the plurality of objects on the shared image screen based on the display data; and
an identification terminal which transmits information of a user,
wherein the display device comprises a receiving section provided on the shared image screen, which acquires information of the user from a touch panel and the identification terminal, and the display data generation device identifies the operation to the object and the user who has conducted the operation based on the operation information to the object acquired from the display device and the information of the user.

9. A computer device comprising:
the display data generation device of claim 1; and
a display section provided on the display data generation device, which displays the plurality of objects on the shared image screen.

10. A nontransitory computer-readable storage medium having a program stored thereon for causing a computer to perform a display control to operate by a generation device which generates display data to display a plurality of objects on a shared image screen utilized by a plurality of users, the program comprising:
making the generation device to function as a processing and judgment section which identifies a user who has conducted an operation to any one of objects when the operation is detected, and judges whether or not a display form of the object should be changed according to a change of the user who has operated the object, and to function as an image processing section to generate display data in which the display form of the object has been changed in accordance with a judgment result of the processing and judgment section.

11. The nontransitory computer-readable storage medium of claim 10, wherein the processing and judgment section judges whether or not the user who has conducted the operation has conducted for the first time by referring information of an operation history of the user to each of the objects that has been stored in advance, and judges that the display form should be changed if the user has conducted the operation for the first time.

12. The nontransitory computer-readable storage medium of claim 11, wherein the processing and judgment section adjusts an amount of change in the display form of the object according to the number of users who have conducted the operation of the object.

13. The nontransitory computer-readable storage medium of claim 12, wherein a weighting factor by each type of operations is set to the operation of the object, and the processing and judgment section adjusts the amount of change in the display form of the object in accordance with the weighting factor according to each type of operations.

14. The nontransitory computer-readable storage medium of claim 10, wherein the display form includes any one of a size of the object, a display density of the object, and a color of display of the object.

15. The nontransitory computer-readable storage medium of claim 10, wherein the operation to the object includes a transfer of the object, decoration of the object, a creation of an object related to the object, and a remark of words related to the object.
